(19) United States
(12) Patent Application Publication
(10) Pub. No.: US 2024/0246336 A1
(43) Pub. Date: Jul. 25, 2024

(54) PRINTING APPARATUS AND PRINTING METHOD

(71) Applicant: SEIKO EPSON CORPORATION, Tokyo (JP)

(72) Inventors: Masamichi SUZUKI, MATSUMOTO-SHI (JP); Kohei UTSUNOMIYA, MATSUMOTO-SHI (JP); Yoshinori NAKAJIMA, MATSUMOTO-SHI (JP); Masaru KUMAGAI, SHIOJIRI-SHI (JP); Yuki ISHII, SHIOJIRI-SHI (JP)

(21) Appl. No.: 18/413,124

(22) Filed: Jan. 16, 2024

(30) Foreign Application Priority Data
Jan. 19, 2023 (JP) 2023-006393

(51) Int. Cl. B41J 2/14; B41J 2/045

(52) U.S. Cl. CPC B41J 2/14; B41J 2/04573

(57) ABSTRACT

A printing apparatus includes: a head including a nozzle surface; and a robot changes a relative position of the head with respect to a workpiece, in which a first printing operation of performing printing on the workpiece is executed by causing the head to eject the liquid, and when a timing at which the first printing operation is started is set as a first timing, a timing at which the first printing operation ends is set as a second timing, a timing between the first timing and the second timing is set as a third timing, and a distance between the plurality of nozzles and the workpiece along a normal direction of the nozzle surface is set as an ejection distance, the ejection distance at one or both of the first timing and the second timing is more than the ejection distance at the third timing.

The present application is based on, and claims priority from JP Application Serial Number 2023-006393, filed Jan. 19, 2023, the disclosure of which is hereby incorporated by reference herein in its entirety.

### BACKGROUND

### 1. Technical Field

The present disclosure relates to a printing apparatus and a printing method.

### 2. Related Art

In the related art, a printing apparatus that performs printing on a surface of a three-dimensional workpiece by an ink jet method using a robot is known. For example, JP-A-2022-70443 describes a printing operation in which a liquid ejection head ejects an ink toward a workpiece while a robot moves the liquid ejection head along a movement path. In this printing operation, a distance between a surface of the workpiece and the liquid ejection head is maintained constant over the entire movement path of the head.

In the technique disclosed in JP-A-2022-70443, there is a case where a vibration caused by an operation of the robot during the execution of the printing operation adversely affects a print image quality. Under such a situation, it is desired to improve the print image quality while considering the vibration due to the operation of the robot.

### SUMMARY

According to an aspect of the present disclosure, there is provided a printing apparatus including: a head including a nozzle surface provided with a plurality of nozzles for ejecting a liquid; and a robot that includes a plurality of joints configured to rotate around rotation axes different from each other, and changes a relative position of the head with respect to a workpiece, in which a first printing operation of performing printing on a first band region on the workpiece is executed by causing the head to eject the liquid while causing the robot to change the relative position of the head with respect to the workpiece, and when a timing at which the first printing operation is started is set as a first timing, a timing at which the first printing operation ends is set as a second timing, a timing between the first timing and the second timing is set as a third timing, and a distance between the plurality of nozzles and the workpiece along a normal direction of the nozzle surface is set as an ejection distance, the ejection distance at one or both of the first timing and the second timing is more than the ejection distance at the third timing.

According to another aspect of the present disclosure, there is provided a printing apparatus including: a head including a nozzle surface provided with a plurality of nozzles for ejecting a liquid; and a robot that includes a plurality of joints configured to rotate around rotation axes different from each other, and changes a relative position of the head with respect to a workpiece, in which a first printing operation of performing printing on a first band region on the workpiece is executed by causing the head to eject the liquid while causing the robot to change the relative position of the head with respect to the workpiece, and when a timing at which the first printing operation is started is set as a first timing, a timing at which the first printing operation ends is set as a second timing, a timing between the first timing and the second timing is set as a third timing, and an angle formed by a virtual straight line extending from the plurality of nozzles in a normal direction of the nozzle surface and a surface of the workpiece at an intersection point of the virtual straight line and the surface of the workpiece is set as a landing angle, the landing angle at one or both of the first timing and the second timing is less than the landing angle at the third timing.

According to still another aspect of the present disclosure, there is provided a printing method using a head including a nozzle surface provided with a plurality of nozzles for ejecting a liquid, and a robot that includes a plurality of joints configured to rotate around rotation axes different from each other, and changes a relative position of the head with respect to a workpiece, the printing method including: when a first printing operation of performing printing on a first band region on the workpiece is executed by causing the head to eject the liquid while causing the robot to change the relative position of the head with respect to the workpiece, acquiring path information on a set of a plurality of teaching points that define the relative position between the workpiece and the head in a virtual space before the execution of the first printing operation; and executing the first printing operation by using the path information, in which when a timing at which the first printing operation is started is set as a first timing, a timing at which the first printing operation ends is set as a second timing, a timing between the first timing and the second timing is set as a third timing, and a distance between the plurality of nozzles and the workpiece along a normal direction of the nozzle surface is set as an ejection distance, the plurality of teaching points include a first teaching point which is a teaching point indicating the relative position between the workpiece and the head at the first timing, a second teaching point which is a teaching point indicating the relative position between the workpiece and the head at the second timing, and a third teaching point which is a teaching point indicating the relative position between the workpiece and the head at the third timing, and in the virtual space, the ejection distance based on one or both of the first teaching point and the second teaching point is more than the ejection distance based on the third teaching point.

### BRIEF DESCRIPTION OF THE DRAWINGS

FIG. 1 is a perspective view illustrating an overview of a printing apparatus according to a first embodiment.

FIG. 2 is a block diagram illustrating an electric configuration of the printing apparatus according to the first embodiment.

FIG. 3 is a perspective view illustrating a schematic configuration of a head unit.

FIG. 4 is a diagram illustrating a flow of a printing method according to the first embodiment.

FIG. 5 is a diagram describing a first band region in the first embodiment.

FIG. 6 is a perspective view describing a trajectory of a head when a printing operation according to a reference example is executed.

FIG. 7 is a diagram describing a movement path of the head when the printing operation according to the reference example is executed.

FIG. 8 is a diagram describing an ejection distance and a landing angle.

FIG. 9 is a perspective view describing a trajectory of a head when a first printing operation is executed in the first embodiment.

FIG. 10 is a diagram describing a movement path of the head when the first printing operation is executed in the first embodiment.

FIG. 11 is a diagram illustrating a flow of a printing method according to a second embodiment.

FIG. 12 is a diagram describing a first band region and a second band region in the second embodiment.

FIG. 13 is a perspective view describing a trajectory of a head when a first printing operation and a second printing operation are executed in the second embodiment.

FIG. 14 is a diagram describing a movement path of the head when the first printing operation is executed in the second embodiment.

FIG. 15 is a diagram describing a movement path of the head when the second printing operation is executed in the second embodiment.

### DESCRIPTION OF EMBODIMENTS

Hereinafter, appropriate embodiments according to the present disclosure will be described with reference to the accompanying drawings. In the drawings, dimensions and scale of each portion are appropriately different from the actual ones, and some portions are schematically illustrated for easy understanding. In addition, the scope of the present disclosure is not limited to the forms unless the present disclosure is particularly limited in the following description.

In the following, for convenience of description, an X-axis, a Y-axis, and a Z-axis that intersect with each other are appropriately used. In the following, one direction along the X-axis is an X1 direction, and a direction opposite to the X1 direction is an X2 direction. In the same manner, directions opposite to each other along the Y-axis are a Y1 direction and a Y2 direction. Further, directions opposite to each other along the Z-axis are a Z1 direction and a Z2 direction.

Here, the X-axis, the Y-axis, and the Z-axis correspond to the coordinate axes of the world coordinate system set in a space in which a robot 2, which will be described below, is installed. Typically, the Z-axis is a vertical axis, and the Z2 direction corresponds to a downward direction in the vertical direction. A base coordinate system based on a position of a base portion 210, which will be described below, of the robot 2 is associated with the world coordinate system by calibration. In the following, for convenience, a case where an operation of the robot 2 is controlled by using the world coordinate system as a robot coordinate system will be illustrated.

The Z-axis may not be the vertical axis. Further, the X-axis, the Y-axis, and the Z-axis are typically orthogonal to each other, but the present disclosure is not limited to this, and the X-axis, the Y-axis, and the Z-axis may not be orthogonal to each other. For example, the X-axis, Y-axis, and Z-axis may intersect with each other at an angle within a range equal to or more than 80° and equal to or less than 100°.

### 1-1. Overview of Printing Apparatus

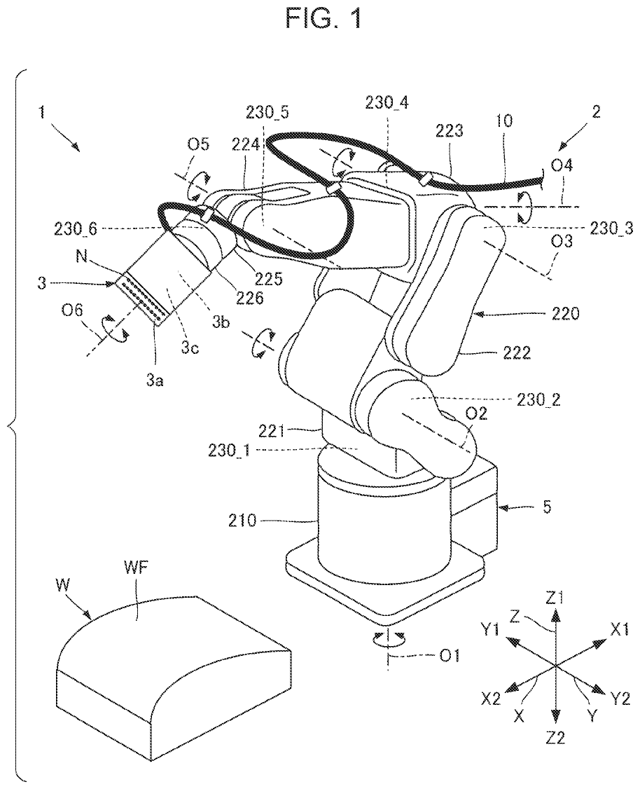

FIG. 1 is a perspective view illustrating an overview of a printing apparatus 1 according to a first embodiment. The printing apparatus 1 is an apparatus that performs printing on a surface of a three-dimensional workpiece W by an ink jet method.

The workpiece W has a surface WF as a printing target. In the example illustrated in FIG. 1, the surface WF is a projecting curved surface projecting in the Z1 direction to be parallel with the Y-axis. A curvature of the surface WF may differ depending on a position of the surface WF in a direction along the X-axis, or may be constant over the entire region of the surface WF in a direction along the X-axis. The printing target may be a surface other than the surface WF among the plurality of surfaces of the workpiece W. A size, a shape, or an installation posture of the workpiece W is not limited to the example illustrated in FIG. 1, and is any size, shape, or installation posture. For example, the surface WF may have a shape along a spherical surface.

As illustrated in FIG. 1, the printing apparatus 1 includes a robot 2, a head unit 3, a controller 5, and a piping portion 10. Hereinafter, first, the robot 2, the head unit 3, the controller 5, and the piping portion 10 will be briefly described in order with reference to FIG. 1.

The robot 2 is a robot that changes a position and a posture of the head unit 3 in the world coordinate system. In the example illustrated in FIG. 1, the robot 2 is a so-called 6-axis vertical articulated robot.

As illustrated in FIG. 1, the robot 2 has the base portion 210 and an arm portion 220.

The base portion 210 is a base that supports the arm portion 220. In the example illustrated in FIG. 1, the base portion 210 is fixed to a floor surface facing the Z1 direction or an installation surface such as a base by screwing or the like. The installation surface to which the base portion 210 is fixed may be a surface facing in any direction, is not limited to the example illustrated in FIG. 1, and may be, for example, a surface provided by a wall, a ceiling, a movable trolley, or the like.

The arm portion 220 is a 6-axis robot arm having a base end attached to the base portion 210 and a tip that changes a position and a posture three-dimensionally with respect to the base end. Specifically, the arm portion 220 has arms 221, 222, 223, 224, 225, and 226 also referred to as links, which are coupled in this order.

The arm 221 is rotatably coupled to the base portion 210 around a rotation axis O1 via a joint 230_1. The arm 222 is rotatably coupled to the arm 221 around a rotation axis O2 via a joint 230_2. The arm 223 is rotatably coupled to the arm 222 around a rotation axis O3 via a joint 230_3. The arm 224 is rotatably coupled to the arm 223 around a rotation axis O4 via a joint 230_4. The arm 225 is rotatably coupled to the arm 224 around a rotation axis O5 via a joint 230_5. The arm 226 is rotatably coupled to the arm 225 around a rotation axis O6 via a joint 230_6.

Each of the joints 230_1 to 230_6 is a mechanism for rotatably coupling one of two adjacent members of the base portion 210 and the arms 221 to 226 to the other. In the following, each of the joints 230_1 to 230_6 may be referred to as a “joint 230”.

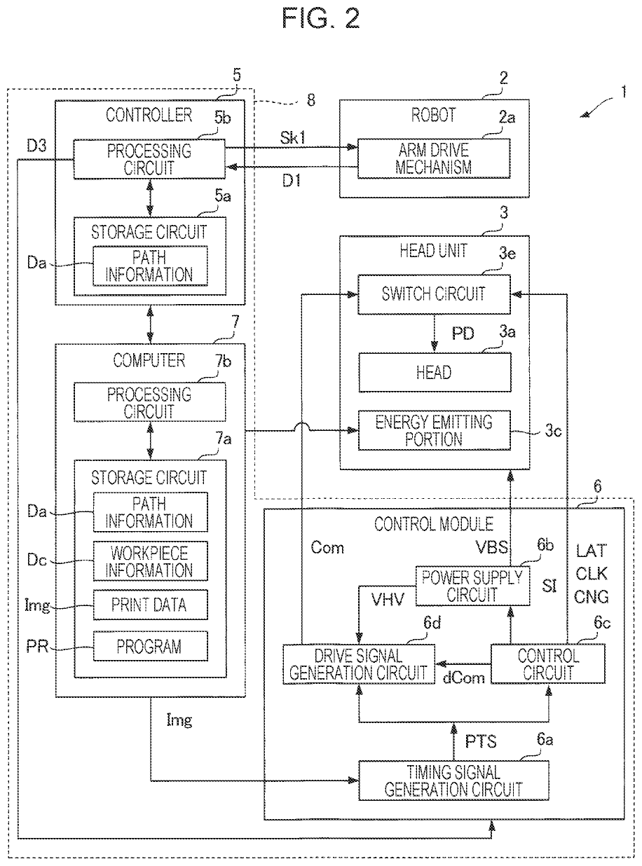

Although not illustrated in FIG. 1, each of the joints 230_1 to 230_6 is provided with a drive mechanism for rotating one of the two adjacent members corresponding to each other to the other. The drive mechanism includes, for example, a motor that generates a drive force for the rotation, a speed reducer that decelerates and outputs the drive force, an encoder such as a rotary encoder that detects the operation amount such as an angle of the rotation, and the like. An aggregation of the drive mechanisms of the joints 230_1 to 230_6 corresponds to an arm drive mechanism 2a illustrated in FIG. 2, which will be described below.

The rotation axis O1 is an axis perpendicular to an installation surface (not illustrated) to which the base portion 210 is fixed. The rotation axis O2 is an axis perpendicular to the rotation axis O1. The rotation axis O3 is an axis parallel with the rotation axis O2. The rotation axis O4 is an axis perpendicular to the rotation axis O3. The rotation axis O5 is an axis perpendicular to the rotation axis O4. The rotation axis O6 is an axis perpendicular to the rotation axis O5.

In this manner, the robot 2 includes a plurality of joints 230 configured to rotate around the mutually different rotation axes O1, O2, O3, O4, O5, and O6. Regarding these rotation axes, “perpendicular” includes not only a case where an angle formed by the two rotation axes is strictly 90°, but also a case where the angle formed by the two rotation axes deviates within a range of approximately 90° to ±5°. In the same manner, “parallel” includes not only a case where the two rotation axes are strictly parallel with each other, but also a case where one of the two rotation axes is inclined within a range of approximately ±5° with respect to the other.

The head unit 3 is mounted on the arm 226 located at the most tip among the arms 221 to 226 of the above robot 2 as an end effector. Here, the head unit 3 is fixed to the arm 226 by screwing or the like.

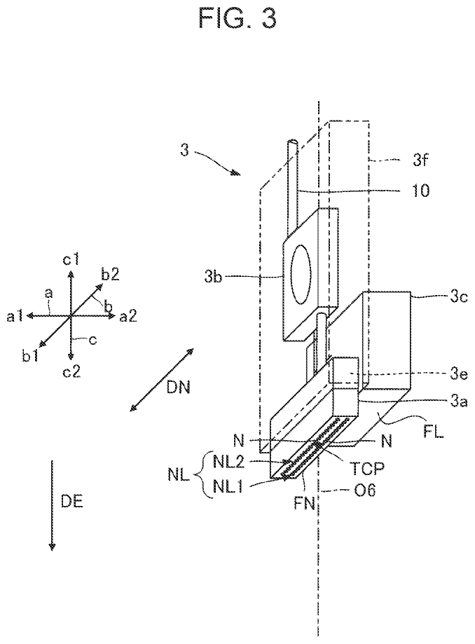

The head unit 3 is an assembly having a head 3a that ejects an ink, which is an example of a “liquid”, toward the workpiece W. In the present embodiment, the head unit 3 has not only the head 3a but also a pressure regulating valve 3b and an energy emitting portion 3c. Details of the head unit 3 will be described below with reference to FIG. 3.

The ink is not particularly limited, and includes, for example, an aqueous ink in which a coloring material such as a dye or a pigment is dissolved in an aqueous solvent, a curable ink using a curable resin such as an ultraviolet curable type, a solvent-based ink in which a coloring material such as a dye or a pigment is dissolved in an organic solvent, and the like. Among the inks, the curable ink is preferably used. The curable ink is not particularly limited, and may have, for example, any of a thermosetting type, a photocurable type, a radiation curable type, an electron beam curable type, and the like, and a photocurable type such as an ultraviolet curable type is preferable. The ink is not limited to the solution, and may be an ink in which a coloring material or the like is dispersed as a dispersant in a dispersion medium. Further, the ink is not limited to an ink containing a coloring material, and may be, for example, an ink containing conductive particles such as metal particles for forming wiring or the like as a dispersant, a clear ink, or a treatment liquid for surface treatment of the workpiece W.

Each of the piping portion 10 and a wiring portion (not illustrated) is coupled to the head unit 3. The piping portion 10 is a piping or a piping group that supplies the ink from an ink tank (not illustrated) to the head unit 3. The wiring portion is a wiring or a wiring group for supplying an electric signal for driving the head 3a. The routing of the wiring portion may have the same manner as or different from the routing of the piping portion 10.

The controller 5 is a robot controller that controls the drive of the robot 2. The computer 7 is a computer such as a desktop type or a notebook type in which a program is installed, and controls the drive of the head unit 3. Hereinafter, an electric configuration of the printing apparatus 1 will be described with reference to FIG. 2, including a detailed description of the controller 5 and computer 7.

### 1-2. Electric Configuration of Printing Apparatus

FIG. 2 is a block diagram illustrating the electric configuration of the printing apparatus 1 according to the first embodiment. In FIG. 2, among components of the printing apparatus 1, electric components are illustrated. As illustrated in FIG. 2, in addition to the components illustrated in FIG. 1 described above, the printing apparatus 1 includes a control module 6 that is communicably connected to the controller 5 and a computer 7 that is communicably connected to the controller 5 and the control module 6. Here, a control portion 8 is configured with the controller 5, the control module 6, and the computer 7. The control portion 8 controls each operation of the robot 2 and the head unit 3. Hereinafter, each portion of the control portion 8 will be described in order with reference to FIG. 2.

Each electrical component illustrated in FIG. 2 may be appropriately divided, a part thereof may be included in another component, or may be integrally formed with the other component. For example, a part or the entirety of the functions of the controller 5 or the control module 6 may be realized by the computer 7, or may be realized by another external apparatus such as a personal computer (PC) coupled to the controller 5 via a network such as a local area network (LAN) or the Internet.

The controller 5 has a function of controlling the drive of the robot 2 and a function of generating a signal D3 for synchronizing an ink ejection operation of the head unit 3 with the operation of the robot 2.

The controller 5 has a storage circuit 5a and a processing circuit 5b.

The storage circuit 5a stores various programs to be executed by the processing circuit 5b and various types of data to be processed by the processing circuit 5b. The storage circuit 5a includes, for example, one or both semiconductor memories of a volatile memory such as a random access memory (RAM) and a non-volatile memory such as a read only memory (ROM), an electrically erasable programmable read-only memory (EEPROM) or a programmable ROM (PROM). A part or all of the storage circuit 5a may be included in the processing circuit 5b.

Path information Da is recorded in the storage circuit 5a.

The path information Da is information which is used for controlling the operation of the robot 2 and indicates a position and a posture of the head 3a in a path along which the head 3a is to be moved when a printing operation is executed. The path information Da of the present embodiment is information on a set of a plurality of teaching points that define relative positions between the workpiece W and the head 3a in a virtual space in each of a first printing operation, a first non-printing operation, and a second non-printing operation, which will be described below. Each of the plurality of teaching points is represented as a coordinate value of a coordinate system set in the virtual space. The coordinate system is not particularly limited, and is, for example, a workpiece coordinate system, a base coordinate system, or a world coordinate system. The path information Da is generated by a processing circuit 7b, and is input from the processing circuit 7b to the storage circuit 5a. When the path information Da is represented by using a coordinate value of the workpiece coordinate system, the path information Da is used for controlling the operation of the robot 2 after conversion from the coordinate value of the workpiece coordinate system to a coordinate value of the base coordinate system or the world coordinate system.

The processing circuit 5b controls an operation of the arm drive mechanism 2a of the robot 2 based on the path information Da, and generates the signal D3. The processing circuit 5b includes, for example, one or more processors such as a central processing unit (CPU). The processing circuit 5b may include a programmable logic device such as a field-programmable gate array (FPGA), instead of the CPU or in addition to the CPU.

Here, the arm drive mechanism 2a is an aggregation of the drive mechanisms of the joints 230_1 to 230_6 described above, and includes a motor for driving the joint of the robot 2 and an encoder that measures a rotation angle of the joint of the robot 2, for each joint 230.

The processing circuit 5b performs an inverse kinematics calculation, which is an arithmetic operation for converting the path information Da into the operation amount such as a rotation angle and a rotation speed of each joint 230 of the robot 2. The processing circuit 5b outputs a control signal Sk1 based on an output D1 from each encoder of the arm drive mechanism 2a so that the operation amount such as the actual rotation angle and the rotation speed of each joint 230 becomes the arithmetic operation result described above based on the path information Da. The control signal Sk1 is a signal for controlling a drive of the motor of the arm drive mechanism 2a. Here, the control signal Sk1 is corrected by the processing circuit 5b based on an output from a distance sensor (not illustrated), as needed.

Further, the processing circuit 5b generates the signal D3, based on the output D1 from at least one of a plurality of encoders included in the arm drive mechanism 2a. For example, the processing circuit 5b generates a trigger signal including a pulse at a timing at which the output D1 from one of the plurality of encoders becomes a predetermined value as the signal D3.

The control module 6 is a circuit that controls an ink ejection operation in the head unit 3 based on the signal D3 output from the controller 5 and print data Img from the computer 7. The control module 6 includes a timing signal generation circuit 6a, a power supply circuit 6b, a control circuit 6c, and a drive signal generation circuit 6d.

The timing signal generation circuit 6a generates a timing signal PTS based on the signal D3. The timing signal generation circuit 6a is configured with, for example, a timer that starts generation of the timing signal PTS by using detection of the signal D3 as a trigger.

The power supply circuit 6b receives power from a commercial power supply (not illustrated) to generate various predetermined potentials. The various generated potentials are appropriately supplied to each portion of the control module 6 and the head unit 3. For example, the power supply circuit 6b generates a power supply potential VHV and an offset potential VBS. The offset potential VBS is supplied to the head unit 3. Further, the power supply potential VHV is supplied to the drive signal generation circuit 6d.

The control circuit 6c generates a control signal SI, a waveform designation signal dCom, a latch signal LAT, a clock signal CLK, and a change signal CNG, based on the timing signal PTS. These signals are synchronized with the timing signal PTS. Among these signals, the waveform designation signal dCom is input to the drive signal generation circuit 6d, and the other signals are input to the switch circuit 3e of the head unit 3.

The control signal SI is a digital signal for designating an operation state of a drive element included in the head 3a of the head unit 3. Specifically, the control signal SI is a signal for designating whether or not to supply a drive signal Com, which will be described below, to the drive element based on the print data Img. With this designation, for example, whether or not to eject inks from a nozzle corresponding to the drive element is designated, and the amount of ink ejected from the nozzle is designated. The waveform designation signal dCom is a digital signal for defining a waveform of the drive signal Com. The latch signal LAT and the change signal CNG are signals for defining an ejection timing of the ink from the nozzle, in combination with the control signal SI, by defining a drive timing of the drive element. The clock signal CLK is a reference clock signal synchronized with the timing signal PTS.

The above control circuit 6c includes, for example, one or more processors such as a CPU. The control circuit 6c may include a programmable logic device such as an FPGA instead of the CPU or in addition to the CPU.

The drive signal generation circuit 6d is a circuit that generates the drive signal Com for driving each drive element included in the head 3a of the head unit 3. Specifically, the drive signal generation circuit 6d includes, for example, a DA conversion circuit and an amplifier circuit. In the drive signal generation circuit 6d, the DA conversion circuit converts the waveform designation signal dCom from the control circuit 6c from a digital signal to an analog signal, and the amplifier circuit uses the power supply potential VHV from the power supply circuit 6b to amplify the analog signal and generate the drive signal Com. Here, among waveforms included in the drive signal Com, a signal of a waveform actually supplied to the drive element is a drive pulse PD. The drive pulse PD is supplied from the drive signal generation circuit 6d to the drive element, via the switch circuit 3e of the head unit 3.

Here, the switch circuit 3e is a circuit including a switching element that switches whether or not to supply at least a part of the waveform included in the drive signal Com as the drive pulse PD based on the control signal SI.

The computer 7 has a function of generating the path information Da, a function of supplying information such as the path information Da to the controller 5, and a function of supplying information such as the print data Img to the control module 6. In addition to these functions, the computer 7 of the present embodiment has a function of controlling a drive of the energy emitting portion 3c.

The computer 7 has a storage circuit 7a and the processing circuit 7b. In addition, although not illustrated, the computer 7 has an input device that accepts an operation from a user, such as a keyboard or a mouse. The computer 7 may have a display device that displays information necessary for generating the path information Da, such as a liquid crystal panel.

The storage circuit 7a stores various programs to be executed by the processing circuit 7b and various types of data to be processed by the processing circuit 7b. The storage circuit 7a includes, for example, one or both semiconductor memories of a volatile memory such as a RAM and a non-volatile memory such as a ROM, an EEPROM, or a PROM. A part or all of the storage circuit 7a may be included in the processing circuit 7b.

The path information Da, workpiece information Dc, the print data Img, and a program PR are recorded in the storage circuit 7a.

The workpiece information Dc is data representing a shape of at least a part of the workpiece W. Specifically, the workpiece information Dc is, for example, three-dimensional data such as a standard triangulated language (STL) format representing the shape of the workpiece W by a plurality of polygons. The workpiece information Dc includes coordinate information that is information on coordinates of each vertex of the polygon, and vector information that is information on a normal vector indicating the front and back of a polygon surface. The workpiece information Dc is obtained by performing conversion processing, as needed, on computer-aided design (CAD) data indicating a three-dimensional shape of the workpiece W. The workpiece information Dc may be represented by using coordinate values of the workpiece coordinate system, or may be represented by point group data using coordinate values of the base coordinate system or the world coordinate system. Further, the workpiece information Dc may be represented by an equation or the like, and a format of the workpiece information Dc can be appropriately converted as needed.

The print data Img is information indicating an image to be printed on the workpiece W for each path of a printing path indicated by the path information Da.

The program PR is a program for executing acquisition of the path information Da and printing based on the path information Da.

The processing circuit 7b realizes each of the functions described above by executing a program such as the program PR. The processing circuit 7b includes, for example, one or more processors such as a CPU. The processing circuit 7b may include a programmable logic device such as an FPGA instead of the CPU or in addition to the CPU.

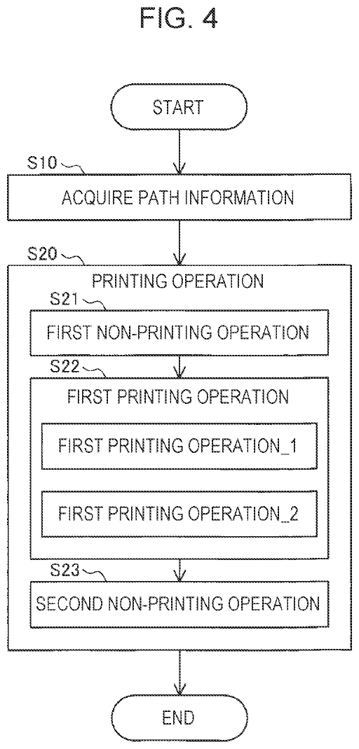

The processing circuit 7b realizes various functions for a printing method, which will be described below, including acquisition of the path information Da and the like, by executing the program PR. Details of the printing method will be described below with reference to FIGS. 4 to 10.

As described above, by controlling the drive of the robot 2 based on the path information Da and controlling the drive of the head 3a based on the print data Img and the signal D3, the printing operation is performed. In the printing operation, while the robot 2 changes the position and the posture of the head 3a based on the path information Da, the head 3a ejects inks from the head 3a toward the workpiece W at an appropriate timing based on the print data Img and the signal D3. Thus, an image based on the print data Img is formed at the workpiece W.

The printing operation of the present embodiment includes a first non-printing operation, a first printing operation, and a second non-printing operation, in this order. As will be described in detail below, in the first printing operation, the head 3a ejects inks while the robot 2 changes a relative position of the head 3a with respect to the workpiece W. On the other hand, in each of the first non-printing operation and the second non-printing operation, the ink is not ejected from the head 3a while the robot 2 changes the relative position between the workpiece W and the head 3a.

### 1-3. Configuration of Head Unit

FIG. 3 is a perspective view illustrating a schematic configuration of the head unit 3. In the following description, for convenience, an a-axis, a b-axis, and a c-axis that intersect with each other will be appropriately used. Further, in the following description, one direction along the a-axis is an a1 direction, and a direction opposite to the a1 direction is an a2 direction. In the same manner, directions opposite to each other along the b-axis are a b1 direction and a b2 direction. Further, directions opposite to each other along the c-axis are a c1 direction and a c2 direction.

Here, the a-axis, the b-axis, and the c-axis correspond to coordinate axes of a tool coordinate system set in the head unit 3, and relative positions and relationships of postures with the world coordinate system or the robot coordinate system described above are changed by the operation of the robot 2 described above. In the example illustrated in FIG. 3, the c-axis is an axis parallel with the rotation axis O6 described above. The a-axis, the b-axis, and the c-axis are typically orthogonal to each other without being limited thereto, and may intersect at an angle within a range of 80° or more and 100° or less, for example. The tool coordinate system and the base coordinate system or the robot coordinate system are associated with each other by calibration.

The tool coordinate system is set with reference to a tool center point TCP. Therefore, the position and the posture of the head 3a are defined with reference to the tool center point TCP. In the example illustrated in FIG. 3, the tool center point TCP is disposed at a center of a nozzle surface FN. A position of the tool center point TCP is not limited to the example illustrated in FIG. 3, and may be, for example, a position separated from the head 3a in an ejection direction DE of inks. In this case, a movement path RU, which will be described below, is set on the surface of the workpiece W.

As described above, the head unit 3 has the head 3a, the pressure regulating valve 3b, and the energy emitting portion 3c. The head 3a, the pressure regulating valve 3b, and the energy emitting portion 3c are supported by a support body 3f illustrated by an alternate long and short dash line in FIG. 3. In the example illustrated in FIG. 3, the number of each of the head 3a and the pressure regulating valve 3b included in the head unit 3 is one. Meanwhile, the number is not limited to the example illustrated in FIG. 3, and may be equal to or more than 2. Further, an installation position of the pressure regulating valve 3b is not limited to the arm 226, and may be, for example, another arm or the like, or may be a fixed position with respect to the base portion 210.

The support body 3f is made of, for example, a metal material or the like, and is a substantially rigid body. In the example illustrated in FIG. 3, the support body 3f has a flat box shape. A shape of the support body 3f is not limited to the example illustrated in FIG. 3, and is any shape.

The above support body 3f is mounted to the arm 226 described above. Therefore, the head 3a, the pressure regulating valve 3b, and the energy emitting portion 3c are collectively supported on the arm 226 by the support body 3f. Therefore, each relative position of the head 3a, the pressure regulating valve 3b, and the energy emitting portion 3cwith respect to the arm 226 is fixed. In the example illustrated in FIG. 3, the pressure regulating valve 3b is disposed at a position in the c1 direction with the head 3a. The energy emitting portion 3c is disposed at a position in the a2 direction with respect to the head 3a.

The head 3a has the nozzle surface FN and a plurality of nozzles N that are opened on the nozzle surface FN. The nozzle surface FN is a nozzle surface through which the nozzle N is opened, and is made of, for example, a material such as silicon (Si) or metal, or when another member is disposed as a component of the head unit 3 on a plane extending from the plate surface, the nozzle surface FN is a surface configured with a plate surface of a nozzle plate and a surface of the other member. Here, the nozzle plate is a member in which the plurality of nozzles N are formed at a plate-shaped member made of silicon, metal, or the like. The other member is, for example, a fixing plate and a cover head. The fixing plate is a member provided around the nozzle plate for the purpose of fixing or protecting the nozzle plate. The cover head is a member provided for the purpose of protecting the head 3a, and has a portion disposed around the nozzle plate. The fixing plate and the cover head may not be provided depending on the configuration of the head 3a. Further, positions of surfaces of the fixing plate and the cover head in a direction along the c-axis are different from a plate surface of the nozzle plate by a maximum of 0.8 mm, in some cases. In the example illustrated in FIG. 3, the nozzle surface FN is configured with only a plate surface of one nozzle plate. Meanwhile, the nozzle surface FN may have a plurality of nozzle plates, in this case, the nozzle surface FN is defined as a surface including a plurality of nozzle plates. In the example illustrated in FIG. 3, a normal direction of the nozzle surface FN, that is, the ejection direction DE of the inks from the nozzle N is the c2 direction. Strictly, there is a case where the ejection direction DE and the c2 direction are not parallel with each other due to inertia, an influence of an air flow or the like by the operation of the robot 2, and in the present embodiment, such an error is not considered.

The plurality of nozzles N are divided into a first nozzle array NL1 and a second nozzle array NL2 aligned apart from each other in a direction along the a-axis. Each of the first nozzle array NL1 and the second nozzle array NL2 is a set of the plurality of nozzles N linearly arrayed in a nozzle array direction DN which is a direction along the b-axis. Here, elements related to each of the nozzles N of the first nozzle array NL1 and elements related to each of the nozzles N of the second nozzle array NL2 in the head 3a are configured to be substantially symmetrical with each other in a direction along the a-axis.

Meanwhile, positions of the plurality of nozzles N in the first nozzle array NL1 and the plurality of nozzles N in the second nozzle array NL2 in the direction along the b-axis may or may not coincide with each other. The elements related to each nozzle N of one of the first nozzle array NL1 and the second nozzle array NL2 may be omitted. In the following, a configuration in which the positions of the plurality of nozzles N in the first nozzle array NL1 and the plurality of nozzles N in the second nozzle array NL2 in the direction along the b-axis coincide with each other will be described.

In the following, the entire first nozzle array NL1 and the entire second nozzle array NL2 may be referred to as a nozzle array NL. The nozzle array NL includes the first nozzle array NL1 and the second nozzle array NL2.

Although not illustrated, the head 3a has a piezoelectric element which is a drive element and a cavity for accommodating inks, for each nozzle N. Here, the piezoelectric element ejects an ink in the ejection direction DE from a nozzle corresponding to the cavity, by changing a pressure of the cavity corresponding to the piezoelectric element. Such a head 3a can be obtained, for example, by bonding a plurality of substrates such as a silicon substrate appropriately processed by etching or the like with an adhesive or the like. As the drive element for ejecting the ink from the nozzle, a heater that heats the ink in the cavity may be used instead of the piezoelectric element.

Ink is supplied to the head 3a from an ink tank (not illustrated) via the piping portion 10. Here, the piping portion 10 is coupled to the head 3a via the pressure regulating valve 3b.

The pressure regulating valve 3b is a valve mechanism that is opened and closed according to a pressure of the ink in the head 3a. By this opening and closing, the pressure of the ink in the head 3a is maintained at a negative pressure within a predetermined range even when a positional relationship between the head 3a and the ink tank (not illustrated) described above is changed. Therefore, a meniscus of the ink formed at the nozzle N of the head 3a is stabilized. As a result, it is possible to prevent air bubbles from entering the nozzle N, and the ink from overflowing from the nozzle N. Further, the ink from the pressure regulating valve 3b is appropriately distributed to a plurality of locations of the head 3a via a branch flow path (not illustrated). Here, the ink from the ink tank (not illustrated) is supplied to the pressure regulating valve 3b at a predetermined pressure by a pump or the like.

The energy emitting portion 3c emits energy such as light, heat, an electron beam, or radiation for curing or solidifying the ink on the workpiece W. For example, when the ink has ultraviolet curability, the energy emitting portion 3c is configured with a light emitting element such as a light emitting diode (LED) that emits ultraviolet rays. Further, the energy emitting portion 3c may appropriately have an optical component such as a lens for adjusting an emitting direction or an emitting range of the energy.

### 1-4. Printing Method

FIG. 4 is a diagram illustrating a flow of a printing method according to the first embodiment. The printing method is executed by using the head 3a and the robot 2 described above, and as illustrated in FIG. 4, the printing method includes step S10 of acquiring the path information Da, step S20 of executing a printing operation using the path information Da, in this order.

In step S10, by setting a plurality of teaching points that define a relative position between the workpiece W and the head 3a in a virtual space, the path information Da on a set of the plurality of teaching points is acquired. This acquisition is performed, for example, by on-line teaching or offline teaching.

In step S20, printing is performed on the workpiece W by using the path information Da acquired in step S10. In the present embodiment, step S20 includes step S21 of executing a first non-printing operation, step S22 of executing a first printing operation, and step S23 of executing a second non-printing operation, in this order.

The first non-printing operation in step S21 is an operation in which an ink is not ejected from the head 3a while the robot 2 changes the relative position between the workpiece W and the head 3a immediately before the execution of the first printing operation. Such a first non-printing operation is used, for example, as a run-up operation in which the head 3a is assisted immediately before the first printing operation. Therefore, the head 3a can be moved at a desired moving speed at a timing at which the first printing operation is started. On the other hand, the second non-printing operation in step S23 is an operation in which the ink is not ejected from the head 3a while the robot 2 changes the relative position between the workpiece W and the head 3a immediately after the execution of the first printing operation. Such a second non-printing operation is used, for example, as a coasting operation in which the head 3a coasts immediately after the first printing operation. Therefore, the head 3a can be moved at a desired moving speed at a timing at which the first printing operation ends.

In the example illustrated in FIG. 4, the first printing operation in step S22 is executed by selecting one of a first printing operation_1 and a first printing operation_2. The first printing operation_1 is a first printing operation of printing on a first band region RP1_1 which will be described below. The first printing operation_2 is a first printing operation of printing on a first band region RP1_2 which will be described below.

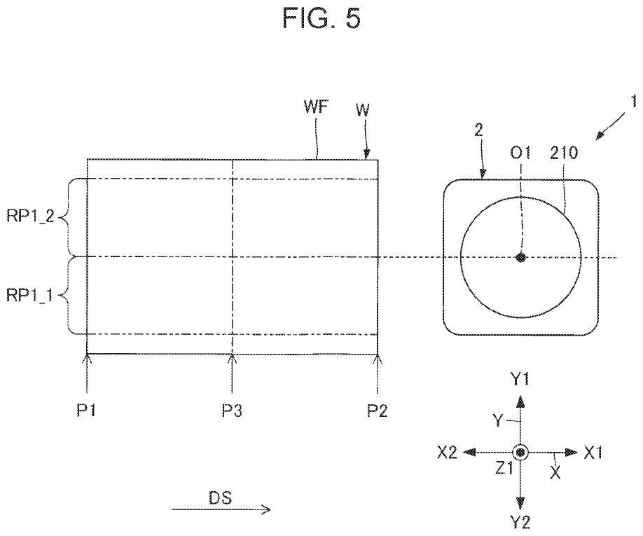

FIG. 5 is a diagram describing the first band regions RP1_1 and RP1_2 in the first embodiment, and is a plan view when the robot 2 and the workpiece W are viewed in the Z2 direction. In FIG. 5, an arm portion 220 of the robot 2 or the head unit 3 are not illustrated. In the first printing operation in step S22 illustrated in FIG. 4 described above, while the robot 2 changes the relative position of the head 3a with respect to the workpiece W, the head 3a ejects the ink. Therefore, printing is performed on the first band region RP1_1 or the first band region RP1_2 on the workpiece W. In the following, each of the first band region RP1_1 and the first band region RP1_2 may be referred to as a first band region RP1.

The first band region RP1 is a region of the printable surface WF in a band shape extending in a scanning direction with a width defined by a length of the nozzle array NL of the head 3a when the head 3a is moved relative to the workpiece W along the scanning direction and the ink is ejected from the head 3a. The length of the nozzle array NL defining the width is a length of a group of the plurality of nozzles N configured to eject the ink among the plurality of nozzles N constituting the nozzle array NL, and may be variable depending on a position for each scanning or in the scanning direction.

In the example illustrated in FIG. 5, the workpiece W is located at a position in the X2 direction with respect to the base portion 210 of the robot 2, and each of the first band region RP1_1 and the first band region RP1_2 extends in a direction along the X-axis. Here, when executing the first printing operation, the robot 2 moves the head 3a in a main scanning direction DS, which is the X1 direction or the X2 direction when viewed in a direction along the Z-axis. Therefore, when performing printing on an end of the first band region RP1 in the X2 direction, the arm portion 220 of the robot 2 is in an extended state. On the other hand, when performing printing on an end of the first band region RP1 in the X1 direction, the arm portion 220 of the robot 2 is in a contracted state.

In this manner, when performing printing on the end of the first band region RP1 in the X1 direction or the X2 direction, the arm portion 220 of the robot 2 is in a state close to an operation limit, in some cases. When the amount of rotation of each joint 230 of the robot 2 is further increased in a state close to the operation limit of the arm portion 220 of the robot 2, there is a problem in that a print image quality due to a vibration caused by the operation of the robot 2 is likely to deteriorate. The operation limit of the arm portion 220 of the robot 2 means, for example, that the arm portion 220 cannot be further extended or contracted due to the structure.

In addition, in the example illustrated in FIG. 5, based on a virtual straight line passing through the rotation axis O1 when viewed in a direction along the Z-axis, the first band region RP1_1 is located in the Y2 direction. Meanwhile, the first band region RP1_2 is located in the Y1 direction. In this manner, a center line of the first band region RP1 does not coincide with the virtual straight line passing through the rotation axis O1 when viewed in the direction along the Z-axis.

When the printing is performed on such a first band region RP1, the number of joints 230 to be required for the operation of the robot 2 is large, as compared with a mode in which the center line of the first band region RP1 coincides with the virtual straight line passing through the rotation axis O1 when viewed in the direction along the Z-axis. Specifically, in the mode in which the center line of the first band region RP1 coincides with the virtual straight line passing through the rotation axis O1 when viewed in the direction along the Z-axis, it is sufficient to operate only the three joints 230 of the rotation axes O2, O3, and O5 orthogonal to the rotation axis O1, that is, the joints 230_2, 230_3, and 230_5, during the printing. On the other hand, in a mode in which the center line of the first band region RP1 does not coincide with the virtual straight line passing through the rotation axis O1 when viewed in the direction along the Z-axis, it is necessary to operate all the joints 230 of the robot 2 at a time of the printing.

Therefore, when the printing is performed on the first band region RP1, the vibration caused by the operation of the joint 230 of the robot 2 is likely to affect the print image quality, as compared with the mode in which the center line of the first band region RP1 coincides with the virtual straight line passing through the rotation axis O1 when viewed in the direction along the Z-axis.

Therefore, in the first printing operation, as will be described in detail below, a movement path of the head 3a is set such that the amount of rotation of each joint 230 of the robot 2 is reduced when performing the printing on one end or both ends of the first band region RP1 in one or both of the X1 direction and the X2 direction.

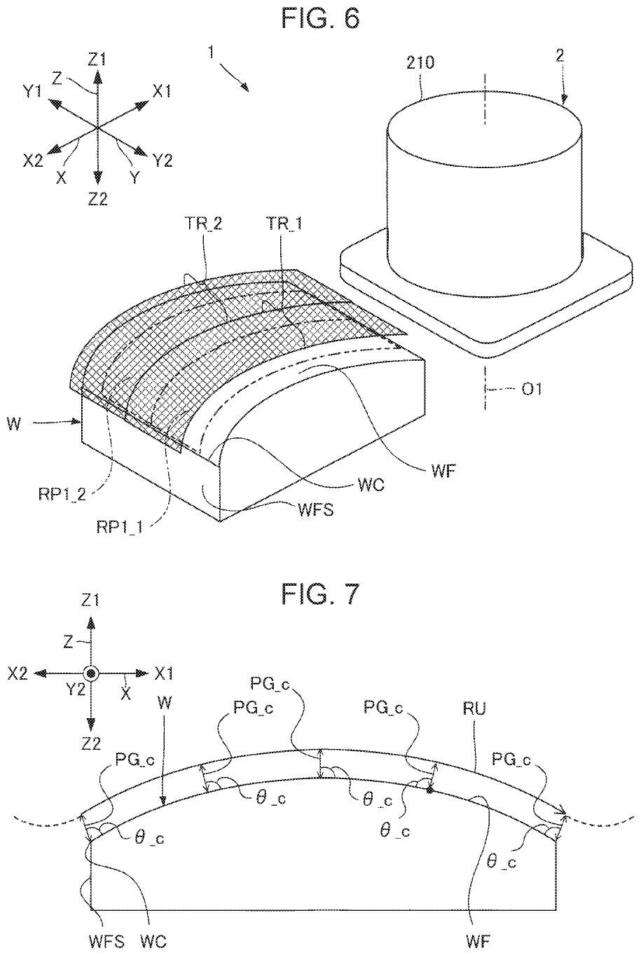

FIG. 6 is a perspective view describing trajectories TR_1 and TR_2 of the head 3a when a printing operation according to a reference example is executed. In FIG. 6, the arm portion 220 of the robot 2 and the head unit 3 are not illustrated. The trajectory TR_1 is a trajectory of the nozzle array NL of the head 3a at a time of printing on the first band region RP1_1, and is visually recognizable by shaded in FIG. 6. The trajectory TR_2 is a trajectory of the nozzle array NL of the head 3a at a time of printing on the first band region RP1_2, and is visually recognizable by shaded in FIG. 6. Here, a distance between the trajectories TR_1 and the TR_2, and the workpiece W is constant. In the present embodiment, since the tool center point TCP is set on the nozzle surface FN, it can be said that each of the trajectories TR_1 and the TR_2 is a trajectory of the nozzle surface FN.

FIG. 7 is a diagram describing the movement path RU of the head 3a when a printing operation according to the reference example is executed, and is a side view when the workpiece W is viewed in the Y1 direction. The movement path RU is the center line of the trajectory TR_1 or the trajectory TR_2 illustrated in FIG. 6 described above, and is defined by a teaching point indicated by the path information Da, as will be described in detail below. In FIG. 7, for convenience, a world coordinate system is set in a virtual space for defining the movement path RU of the head 3a.

As illustrated in FIG. 7, a distance between the movement path RU and the surface WF of the workpiece W is constant. Here, when the head 3a is moved along such a movement path RU when the printing operation is executed, both an ejection distance PG from the head 3a to the surface WF and a landing angle θ of inks are constant. In the example illustrated in FIG. 7, the ejection distance PG is constant at the ejection distance PG_c and the landing angle θ is constant at the landing angle θ_c.

In the related art, it is semi-common that both the ejection distance PG and the landing angle θ are set to be constant in this manner. Meanwhile, when both the ejection distance PG and the landing angle θ are constant, since the amount of rotation of each joint 230 of the robot 2 may be further increased in a state of being close to the operation limit of the arm portion 220 of the robot 2 as described above near the start end and the finish end of the movement path RU, the problem described above occurs.

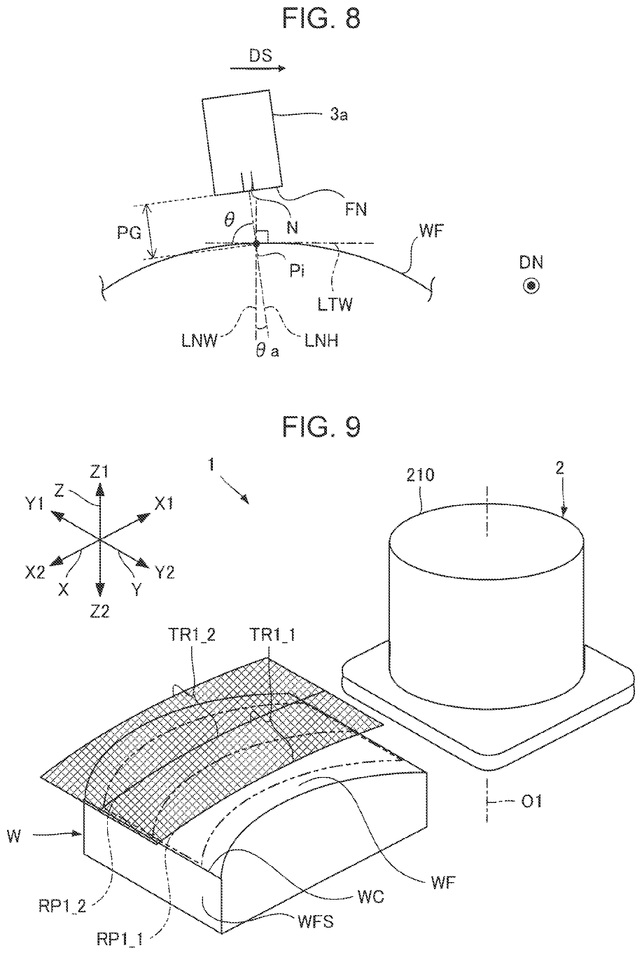

FIG. 8 is a diagram describing the ejection distance PG and the landing angle θ, and is a cross-sectional diagram when viewed in the nozzle array direction DN when a printing operation is executed. As illustrated in FIG. 8, the ejection distance PG is a distance between the plurality of nozzles N and the workpiece W along a normal direction of the nozzle surface FN. The landing angle θ is an angle formed by a virtual straight line LNH extending from the plurality of nozzles N in the normal direction of the nozzle surface FN and the surface of the workpiece W at an intersection point Pi of the virtual straight line LNH and the surface of the workpiece W. That is, the landing angle θ is an angle formed by a tangent line LTW of the surface WF and the virtual straight line LNH at the intersection point Pi of the surface of the workpiece W when viewed in the nozzle array direction DN. In other words, the landing angle θ is an absolute value of a value obtained by subtracting an angle θa formed by the virtual straight line LNH and the normal line LNW of the surface of the workpiece W at the intersection point Pi from 90°. Therefore, the landing angle θ is in a range of more than 0° and 90° or less, or may be in a range of 45° or more and 90° or less, and may be in a range of 60° or more and 90° or less, from the viewpoint of ensuring the print image quality. The intersection point Pi corresponds to a landing position of the ink ejected from the head 3a on the workpiece W, and the landing angle θ is an angle when viewed in the nozzle array direction DN.

FIG. 9 is a perspective view describing a trajectory TR1_1 and a trajectory TR1_2 of the head 3a when a first printing operation according to the first embodiment is executed. In FIG. 9, the arm portion 220 and the head unit 3 of the robot 2 are not illustrated. The trajectory TR1_1 is a trajectory of the nozzle array NL of the head 3a at a time of printing on the first band region RP1_1, and is visually recognizable by shaded in FIG. 9. The trajectory TR1_2 is a trajectory of the nozzle array NL of the head 3a at the time of printing on the first band region RP1_2, and is visually recognizable by shaded in FIG. 9. Here, a distance between each of both ends of the trajectories TR1_1 and TR1_2 in the direction along the X-axis and the workpiece W is more than a distance between a center of the trajectories TR1_1 and TR1_2 in the direction along the X-axis and the workpiece W. In the present embodiment, since the tool center point TCP is set on the nozzle surface FN, it can be said that each of the trajectories TR_1 and the TR_2 is a trajectory of the nozzle surface FN.

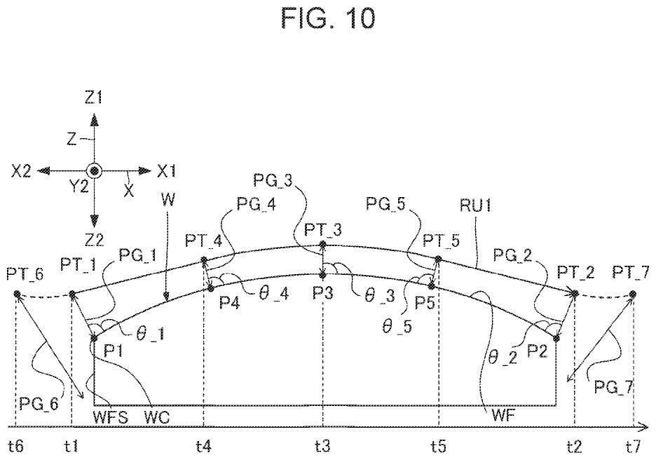

FIG. 10 is a diagram describing a movement path RU1 of the head 3a when the first printing operation according to the first embodiment is executed. FIG. 10 illustrates a case where a movement direction of the head 3a at the time of execution of the first printing operation is the X1 direction when viewed in the direction along the Z-axis.

The movement path RU1 is a center line of the trajectory TR1_1 or the trajectory TR1_2 illustrated in FIG. 9 described above, and is defined by teaching points PT_1 to PT_7. Each of the teaching points PT_1 to PT_7 is a teaching point indicated by the path information Da described above, and defines a relative position between the workpiece W and the head 3a in a virtual space. As described above, since the position and the posture of the head 3a are defined by the position and the posture of the tool center point TCP, it can be said that each of the teaching points PT_1 to PT_7 defines a relative position between the workpiece W and the tool center point TCP in the virtual space. In the following, each of the teaching points PT_1 to PT_7 may be referred to as a teaching point PT. In FIG. 10, for convenience, a world coordinate system is set in the virtual space.

The teaching point PT_1 is an example of a “first teaching point”, and is the teaching point PT indicating the relative position between the workpiece W and the head 3aat a timing t1. The timing t1 is an example of a “first timing”, and is a timing at which the first printing operation is started. The ink ejected from the head 3a at the timing t1 is applied to the surface WF at a position P1, which is an example of a “first position”.

In the example illustrated in FIG. 10, the workpiece W has the surface WF that is an example of a “first surface” and a surface WFS that is an example of a “second surface”. The surface WFS is a surface facing the X2 direction and facing a direction different from a direction of the surface WF. A projecting corner WC by the surface WF and the surface WFS is formed between the surface WF and the surface WFS. Here, in order to perform borderless printing, the position P1 is located at an end at which the corner WC is formed at the surface WF, and a distance between the position P1 and the corner WC is substantially zero. Accordingly, the position P1 is closer to the corner WC and the surface WFS than a position P3.

The teaching point PT_2 is an example of a “second teaching point”, and is the teaching point PT indicating the relative position between the workpiece W and the head 3aat a timing t2. The timing t2 is an example of a “second timing”, and is a timing at which the first printing operation ends. The ink ejected from the head 3a at the timing t2 is applied to the surface WF at a position P2.

The teaching point PT_3 is an example of a “third teaching point”, and is the teaching point PT indicating the relative position between the workpiece W and the head 3aat a timing t3. The timing t3 is an example of a “third timing”, and is a timing between the timing t1 and the timing t2. The ink ejected from the head 3a at timing t3 is applied to the surface WF at the position P3.

The teaching point PT_4 is the teaching point PT indicating the relative position between the workpiece W and the head 3a at a timing t4. The timing t4 is an example of a “fourth timing”, and is a timing between the timing t1 and the timing t3. The ink ejected from the head 3a at the timing t4 is applied to the surface WF at a position P4.

The teaching point PT_5 is the teaching point PT indicating the relative position between the workpiece W and the head 3a at a timing t5. The timing t5 is an example of a “fifth timing”, and is a timing between the timing t2 and the timing t3. The ink ejected from the head 3a at the timing t5 is applied to the surface WF at a position P5.

The teaching point PT_6 is the teaching point PT indicating the relative position between the workpiece W and the head 3a at a timing t6. The timing t6 is an example of a “sixth timing”, and is any timing during execution of a first non-printing operation. The ink ejected from the head 3a at the timing t6 is applied to a position (not illustrated) on the workpiece W.

The teaching point PT_7 is the teaching point PT indicating the relative position between the workpiece W and the head 3a at a timing t7. The timing t7 is an example of a “seventh timing”, and is any timing during execution of a second non-printing operation. The ink ejected from the head 3a at timing t7 is applied to a position (not illustrated) on the workpiece W.

As can be understood from the above, the timings t1 to t7 are arranged over time in order of the timings t6, t1, t4, t3, t5, t2, and t7. Here, since the movement direction of the head 3a is the X1 direction when viewed in the direction along the Z-axis, the teaching points PT_1 to PT_7 are arranged in the X1 direction in order of the teaching points PT_6, PT_1, PT_4, PT_3, PT_5, PT_2, and PT_7. Further, the positions P1 to P5 are arranged in the X1 direction in order of the positions P1, P4, P3, P5, and P2.

In the movement path RU1 defined by the teaching points PT_1 to PT_6, from the viewpoint of reducing the operation amount of the plurality of joints 230 in a state of being close to the operation limit of the robot 2, the ejection distance PG_1 based on the teaching point PT_1, that is, the ejection distance PG at the timing t1 is more than the ejection distance PG_3 based on the teaching point PT_3, that is, the ejection distance PG at the timing t3. In the same manner, the ejection distance PG_2 based on the teaching point PT_2, that is, the ejection distance PG at the timing t2 is more than the ejection distance PG_3.

Further, from the viewpoint of reducing a sudden change of the ejection distance PG in the movement path RU1, the ejection distance PG_4 based on the teaching point PT_4, that is, the ejection distance PG at the timing t4 is more than the ejection distance PG_3, and is less than the ejection distance PG_1. In the same manner, the ejection distance PG_5 based on the teaching point PT_5, that is, the ejection distance PG at the timing t5 is more than the ejection distance PG_3, and is less than the ejection distance PG_2.

Further, from the viewpoint of improving a print image quality while reducing the sudden change of the ejection distance PG in the movement path RU1, the ejection distance PG may be constant over at least a part of a period including the timing t3 and not including the timing t1 and the timing t2. Here, during the execution of the printing operation, for a period other than the period, that is, a period in which the ejection distance PG is changed, from the viewpoint of reducing a deterioration of the print image quality, the ejection distance PG may be changed gradually and continuously. Although not illustrated in FIG. 10, in the movement path RU1, a distance along which the head 3a is scanned while the ejection distance PG is constant may be more than a distance along which the head 3a is scanned while the ejection distance PG is changed. For example, the ejection distance PG_3, the ejection distance PG_4, and the ejection distance PG_5 may be the same distance from each other.

Further, from the viewpoint of smoothing the transition from the other operation to the first printing operation, the ejection distance PG_6 based on the teaching point PT_6, that is, the ejection distance PG at the timing t6 is more than the ejection distance PG_1.

Further, from the viewpoint of smoothing the transition from the first printing operation to the other operation, the ejection distance PG_7 based on the teaching point PT_7, that is, the ejection distance PG at the timing t7 is more than the ejection distance PG at the timing t2.

Further, since the landing angle θ is located within a desired range during the execution of the printing operation, a relative posture between the workpiece W and the head 3a are changed.

Here, from the viewpoint of reducing the operation amount of the plurality of joints 230 in a state of being close to the operation limit of the robot 2, a landing angle θ_1 based on the teaching point PT_1, that is, the landing angle θ at the timing t1 is less than a landing angle θ_3 based on the teaching point PT_3, that is, the landing angle θ at the timing t3. In other words, the landing angle θ_3 is closer to 90° than the landing angle θ_1. In the same manner, a landing angle θ_2 based on the teaching point PT_2, that is, the landing angle θ at the timing t2 is less than the landing angle θ_3. In other words, the landing angle θ_3 is closer to 90° than the landing angle θ_2.

Further, from the viewpoint of reducing a sudden change of the landing angle θ in the movement path RU1, a landing angle θ_4 based on the teaching point PT_4, that is, the landing angle θ at the timing t4 is less than the landing angle θ_3, and is more than the landing angle θ_1. In the same manner, a landing angle θ_5 based on the teaching point PT_5, that is, the landing angle θ at the timing t5 is less than the landing angle θ_3, and is more than the landing angle θ_2.

Further, from the viewpoint of improving the print image quality while reducing the sudden change of the landing angle θ in the movement path RU1, the landing angle θ may be constant over at least a part of a period including the timing t3 and not including the timing t1 and the timing t2. Here, during the execution of the printing operation, for a period other than the period, that is, a period in which the landing angle θ is changed, from the viewpoint of reducing a deterioration of the print image quality, the landing angle θ may be changed gradually and continuously. Although not illustrated in FIG. 10, in the movement path RU1, a distance along which the head 3a is scanned while the landing angle θ is constant may be more than a distance along which the head 3a is scanned while the landing angle θ is changed. For example, the landing angle θ_3, the landing angle θ_4, and the landing angle θ_5 may be the same distance from each other.

Further, from the viewpoint of smoothing the transition from the other operation to the first printing operation, the landing angle θ_6 based on the teaching point PT_6, that is, the landing angle θ at the timing t6 is less than the landing angle θ_1.

Further, from the viewpoint of smoothing the transition from the first printing operation to the other operation, the landing angle θ_7 based on the teaching point PT_7, that is, the landing angle θ at the timing t7 is less than the landing angle θ at the timing t2.

As described above, the printing apparatus 1 includes the head 3a and the robot 2. The head 3a has the nozzle surface FN at which the plurality of nozzles N for ejecting an ink, which is an example of a “liquid” are provided. The robot 2 includes the plurality of joints 230 configured to rotate around rotation axes different from each other, and changes the relative position of the head 3a with respect to the workpiece W.

Thereafter, the printing apparatus 1 executes the first printing operation. In the first printing operation, while the robot 2 changes the relative position of the head 3a with respect to the workpiece W, the head 3a ejects inks. Therefore, printing is performed on the first band region RP1 on the workpiece W.

In addition, a timing at which the first printing operation is started is set as the timing t1 which is an example of the “first timing”, a timing at which the first printing operation ends is set as the timing t2 which is an example of the “second timing”, and a timing between the timing t1 and the timing t2 is set as the timing t3 which is an example of the “third timing”. When a distance between the plurality of nozzles N and the workpiece W along the normal direction of the nozzle surface FN is set as the ejection distance PG, the ejection distance PG at one or both of the timing t1 and the timing t2 is more than the ejection distance PG at the timing t3.

In the above printing apparatus 1, since the ejection distance PG at one or both of the timings t1 and t2 is more than the ejection distance PG at the timing t3, it is possible to reduce the amount of rotation of each joint 230 of the robot 2 at one or both of the timing t1 and the timing t2, as compared with a mode in which the ejection distance PG at each of the timings t1 and t2 is equal to the ejection distance PG at the timing t3. Therefore, it is possible to reduce the deterioration of the print image quality due to the vibration caused by the operation of the robot 2 at one or both of the timing t1 and the timing t2. Therefore, the print image quality can be improved while reducing the vibration due to the operation of the robot 2.

More specifically, printing is performed on the position P1, which is a printing start position of the first band region RP1, at the timing t1, while printing is performed on the position P2, which is a printing end position of the first band region RP1, at the timing t2. Here, a state of the arm portion 220 of the robot 2 at the timing t1 and the timing t2 is a state in which the arm portion 220 of the robot 2 is expanded or shortened, and is a state of being close to the operation limit, as compared with the timing t3 at which the printing is performed on a middle position of the first band region RP1. In particular, when the surface WF of the workpiece W has a projecting curved surface, the state is likely to be close to the operation limit of the arm portion 220. When the ejection distance PG is reduced in the state of being close to the operation limit of the arm portion 220 of the robot 2, the amount of rotation of each joint of the robot 2 may be further increased. Therefore, the print image quality is likely to deteriorate due to the vibration caused by the operation of the robot 2.

Therefore, in the printing apparatus 1, by setting the ejection distance PG at one or both of the timing t1 and the timing t2 to be more than the ejection distance PG at the timing t3, the rotation amount of each joint 230 of the robot 2 at one or both of the timing t1 and the timing t2 is reduced. Thus, a vibration of the head 3a due to the vibration caused by the operation of the robot 2 is reduced. Therefore, a decrease in the print image quality caused by the vibration caused by the operation of the robot 2 is reduced. Hereinafter, an action of improving the image quality by increasing the ejection distance PG at one or both of the timing t1 and the timing t2 is referred to as an “image quality improvement action by vibration reduction”. Since a relationship between the ejection distance PG and the rotation amount of each joint 230 is not necessarily a simple proportional relationship, the rotation amount of each joint can be significantly reduced even when the ejection distance PG is increased by several mm.

Here, in general, as the ejection distance PG is increased, an ink droplet ejected from the head 3a is more likely to be affected by the air flow until the ink droplet ejected from the head 3a lands on the workpiece W. Therefore, the image quality is likely to deteriorate due to a variation in a landing position of the ink droplet on the workpiece W. Hereinafter, such an action of image quality deterioration will be referred to as an “image quality deterioration action due to an increase of the ejection distance PG”.

Meanwhile, when a size of the ink droplet ejected from the head 3a is increased or a plurality of ink droplets ejected from the head 3a are combined before landing on the workpiece W, the ink droplet before the landing on the workpiece W is less likely to be affected by the air flow. Therefore, it is possible to reduce the image quality deterioration action due to an increase of the ejection distance PG. Therefore, the image quality improvement action by vibration reduction described above can be made more than the image quality deterioration action due to an increase of the ejection distance PG. Therefore, by increasing the ejection distance PG at one or both of the printing start position and the printing end position of the first band region RP1 and intentionally lowering followability of the movement path of the head 3a with respect to the workpiece W, it is possible to improve the print image quality.

In the present embodiment, as described above, since the ejection distance PG at the timing t1 is more than the ejection distance PG at the timing t3, the image quality at the printing start position of the first band region RP1 can be improved.

Further, as described above, when a timing between the timing t1 and the timing t3 is the timing t4 which is an example of the “fourth timing”, the ejection distance PG at the timing t4 is more than the ejection distance PG at the timing t3, and is less than the ejection distance PG at the timing t1. Therefore, it is possible to reduce the image quality deterioration of the first band region RP1 due to a sudden change of the ejection distance PG between the timing t1 and the timing t3.

Further, as described above, since the ejection distance PG at the timing t2 is more than the ejection distance PG at the timing t3, the image quality at the printing end position of the first band region RP1 can be improved.

Further, as described above, when a timing between the timing t2 and the timing t3 is the timing t5 which is an example of the “fifth timing”, the ejection distance PG at the timing t5 is more than the ejection distance PG at the timing t3, and is less than the ejection distance PG at the timing t2. Therefore, it is possible to reduce the image quality deterioration of the first band region RP1 due to a sudden change of the ejection distance PG between the timing t2 and the timing t3.

Further, as described above, the ejection distance PG is constant over at least a part of a period including the timing t3 and not including the timing t1 and the timing t2. Therefore, in a state in which the arm portion 220 of the robot 2 is not close to the operation limit, by setting the ejection distance PG to be constant, the image quality deterioration action due to an increase of the ejection distance PG can be reduced. As a result, the image quality can be improved under relatively simple control.

Further, as described above, the relative posture between the workpiece W and the head 3a are changed during the execution of the first printing operation. Therefore, even when the surface WF which is as a printing target of the workpiece W is a curved surface, the image quality can be improved.

Further, as described above, the workpiece W has the surface WF, which is an example of the “first surface”, and the surface WFS, which is an example of the “second surface”. The surface WFS faces in a direction different from a direction of the surface WF, and the projecting corner WC by the surface WF and the surface WFS is formed between the surface WF and the surface WFS. The first band region RP1 is provided on the surface WF. Thereafter, when a position of the surface WF to which an ink is applied from the head 3a at the timing t1 is set as the position P1 which is an example of the “first position”, and a position of the surface WF to which the ink is applied from the head 3a at the timing t3 is set as the position P3 which is an example of the “third position”, the position P1 is closer to the corner WC and the surface WFS than the position P3. Therefore, printing can be performed in a wide range of the surface WF. Further, even though the printing is performed over a wide range of the surface WF in this manner, the ejection distance PG at the timing t1 is more than the ejection distance PG at the timing t3. Therefore, a collision between a side surface of the head 3a and a side surface of the workpiece W or the corner WC can be prevented, and it is possible to reduce the degree of damage to the head 3a or the workpiece W even when the collision occurs.

Further, as described above, the position P1 is located at the end at which the corner WC is formed at the surface WF. That is, a distance between the position P1 and the corner WC is substantially zero. Therefore, it is possible to execute borderless printing.

Further, as described above, immediately before execution of the first printing operation, the printing apparatus 1 executes the first non-printing operation in which inks are not ejected from the head 3a while the robot 2 changes the relative position between the workpiece W and the head 3a. Thereafter, when any timing during the execution of the first non-printing operation is the timing t6 which is an example of the “sixth timing”, the ejection distance PG at the timing t6 is more than the ejection distance PG at the timing t1. Therefore, it is possible to make it difficult for the state of the robot 2 to exceed the operation limit at the timing t6. The printing operation can be efficiently shifted from a position such as a position at which the head 3a is capped to the first printing operation. Further, by reducing the amount of rotation of each joint 230 of the robot 2 at the timing t6, it is possible to reduce the adverse effect of the vibration of the robot 2 at the timing t6 on the image quality at the timing t1. The capping position is, for example, a position at which the head 3a does not contact the robot 2 and is away from the workpiece W during the execution of the printing operation, and is a position at which a cap member configured to cover at least a part of the nozzle surface FN is provided, from the viewpoint of reducing the ink of the nozzle N from drying.

Here, as described above, the printing apparatus 1 further includes the control portion 8 that controls the operation of the robot 2. The control portion 8 acquires the path information Da. The path information Da is information on a set of a plurality of teaching points PT that define the relative positions between the workpiece W and the head 3a in each of the first printing operation and the first non-printing operation in the virtual space. The plurality of teaching points PT include the teaching point PT_1 which is an example of the “first teaching point”, the teaching point PT_3 which is an example of the “third teaching point”, and the teaching point PT_6 which is an example of the “sixth teaching point”. The teaching point PT_1 is the teaching point PT indicating the relative position between the workpiece W and the head 3a at the timing t1. The teaching point PT_3 is the teaching point PT indicating the relative position between the workpiece W and the head 3a at the timing t3. The teaching point PT_6 is the teaching point PT indicating the relative position between the workpiece W and the head 3a at the timing t6. Thereafter, in the virtual space, the ejection distance PG based on the teaching point PT_1 is more than the ejection distance PG based on the teaching point PT_3, and is less than the ejection distance PG based on the teaching point PT_6. Therefore, the ejection distance PG at the timing t1 can be more than the ejection distance PG at the timing t3, and can be less than the ejection distance PG at the timing t6.

Further, as described above, the printing apparatus 1 executes the second non-printing operation immediately after the execution of the first printing operation. In the second non-printing operation, an ink is not ejected from the head 3a while the robot 2 changes the relative position between the workpiece W and the head 3a. Thereafter, when any timing during the execution of the second non-printing operation is the timing t7 which is an example of the “seventh timing”, the ejection distance PG at the timing t7 is more than the ejection distance PG at the timing t2. Therefore, it is possible to make it difficult for the state of the robot 2 to exceed the operation limit at the timing t7. After the first printing operation, the head 3a can be efficiently moved to a position such as a capping position.

Here, as described above, the path information Da is information on a set of the plurality of teaching points PT that define the relative positions between the workpiece W and the head 3a in each of the first printing operation and the second non-printing operation in the virtual space. The plurality of teaching points PT include the teaching point PT_2 which is an example of the “second teaching point”, the teaching point PT_3 which is an example of the “third teaching point”, and the teaching point PT_7 which is an example of the “seventh teaching point”. The teaching point PT_2 is the teaching point PT indicating the relative position between the workpiece W and the head 3a at the timing t2. The teaching point PT_3 is the teaching point PT indicating the relative position between the workpiece W and the head 3a at the timing t3. The teaching point PT_7 is the teaching point PT indicating the relative position between the workpiece W and the head 3a at the timing t7. Thereafter, in the virtual space, the ejection distance PG based on the teaching point PT_2 is more than the ejection distance PG based on the teaching point PT_3, and less than the ejection distance PG based on the teaching point PT_7. Therefore, the ejection distance PG at the timing t2 can be more than the ejection distance PG at the timing t3, and can be less than the ejection distance PG at the timing t7.

Further, as described above, when an angle formed by the virtual straight line LNH extending from the plurality of nozzles N in the normal direction of the nozzle surface FN and the surface of the workpiece W at an intersection point of the virtual straight line LNH and the surface of the workpiece W is set as the landing angle θ, the landing angle θ at one or both of the timing t1 and the timing t2 is less than the landing angle θ at the timing t3. Therefore, as compared with a mode in which the landing angle θ at each of the timing t1 and the timing t2 is equal to the landing angle θ at the timing t3, the amount of rotation of each joint of the robot 2 at one or both of the timing t1 and the timing t2 can be reduced. As a result, it is possible to reduce the deterioration of the print image quality due to the vibration caused by the operation of the robot 2 at one or both of the timing t1 and the timing t2. Therefore, the print image quality can be improved while reducing the vibration due to the operation of the robot 2.

Here, as described above, by making the landing angle θ at the timing t1 less than the landing angle θ at the timing t3, the image quality at the printing start position of the first band region RP1 can be improved.

Further, as described above, by making the landing angle θ at the timing t2 less than the landing angle θ at the timing t3, the image quality at the printing end position of the first band region RP1 can be improved.

The printing method using the head 3a and the robot 2 of the printing apparatus 1 as described above includes step S10 of acquiring, when the first printing operation is to be executed, the path information Da before the execution of the first printing operation, and step S22 of executing the first printing operation using the path information Da. In the above printing method, the print image quality can be improved while reducing the vibration due to the operation of the robot 2.

### 2. SECOND EMBODIMENT

Hereinafter, a second embodiment of the present disclosure will be described. In the embodiment described below as an example, the reference numerals used in the description of the first embodiment will be assigned to elements having the same effects and functions as those of the first embodiment, and each detailed description thereof will be appropriately omitted.

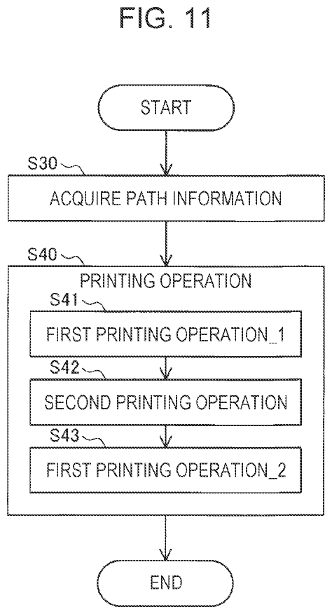

FIG. 11 is a diagram illustrating a flow of a printing method according to the second embodiment. As illustrated in FIG. 11, the printing method includes step S30 of acquiring the path information Da, and step S40 of executing a printing operation using the path information Da in this order.

In step S30, by setting a plurality of teaching points that define a relative position between the workpiece W and the head 3a in a virtual space, the path information Da on a set of the plurality of teaching points is acquired. This acquisition is performed, for example, by on-line teaching or offline teaching.

In step S40, printing is performed on the workpiece W by using the path information Da acquired in step S30. In the present embodiment, step S40 includes step S41 of executing the first printing operation_1, step S42 of executing a second printing operation, and step S43 of executing the first printing operation_2, in this order. Here, the first printing operation_1, the second printing operation, and the first printing operation_2 are printing operations having passes different from each other. Further, between two printing operations of performing printing on regions adjacent to each other, the robot 2 executes a line alignment operation in which the head 3a is moved in a direction intersecting the main scanning direction DS.

A first non-printing operation in the same manner as step S21 of the first embodiment may be performed immediately before one or both of the first printing operations in step S41 and step S43. A second non-printing operation in the same manner as step S23 of the first embodiment may be performed immediately after one or both of the first printing operations in step S41 and step S43.

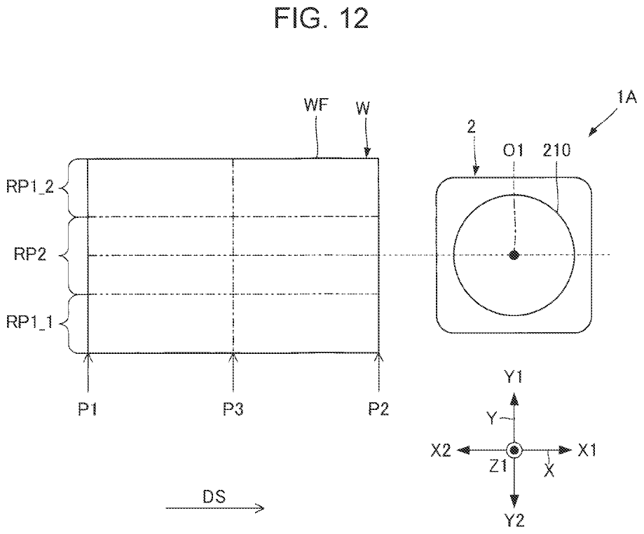

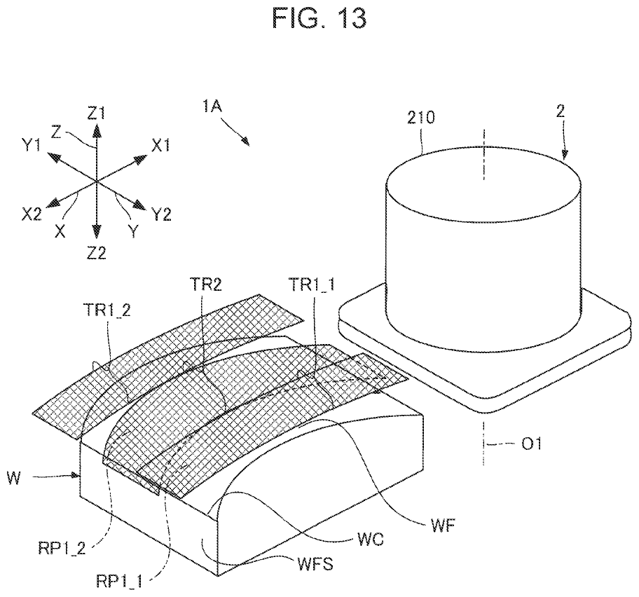

FIG. 12 is a diagram describing the first band regions RP1_1 and RP1_2 and a second band region RP2 according to the second embodiment. In the first printing operation in step S41 illustrated in FIG. 11 described above, in the same manner as the first printing operation of the first embodiment, the head 3a ejects inks while the robot 2 changes the relative position of the head 3a with respect to the workpiece W. Therefore, printing is performed on the first band region RP1_1 on the workpiece W. In the same manner, in the first printing operation in step S44 illustrated in FIG. 11 described above, in the same manner as the first printing operation of the first embodiment, the head 3a ejects inks while the robot 2 changes the relative position of the head 3a with respect to the workpiece W. Therefore, printing is performed on the first band region RP1_2 on the workpiece W.

In the present embodiment as well, in the same manner as the first embodiment, regarding each of the first band regions RP1_1 and RP1_2, a center line of the first band region RP1 does not coincide with a virtual straight line passing through the rotation axis O1 when viewed in the direction along the Z-axis. Meanwhile, in the present embodiment, the second band region RP2 is interposed between the first band region RP1_1 and the first band region RP1_2.

Printing by the second printing operation in step S42 illustrated in FIG. 11 described above is performed on the second band region RP2. That is, in the second printing operation, while the robot 2 changes the relative position of the head 3a with respect to the workpiece W, the head 3a ejects inks. Therefore, the printing is performed on the second band region RP2 on the workpiece W.

The second band region RP2 is a region of the printable surface WF in a band shape extending in a scanning direction with a width defined by a length of the nozzle array NL of the head 3a when the head 3a is moved relative to the workpiece W along the scanning direction and the ink is ejected from the head 3a. The length of the nozzle array NL defining the width is a length of a group of the plurality of nozzles N configured to eject the ink among the plurality of nozzles N constituting the nozzle array NL, and may be variable depending on a position for each scanning or in the scanning direction. In addition, a width of the second band region RP2 may be the same as or different from the width of the first band region RP1.

In the example illustrated in FIG. 11, the second band region RP2 extends in the direction along the X-axis. Here, when executing the second printing operation, the robot 2 moves the head 3a in the X1 direction or the X2 direction when viewed in the direction along the Z-axis. Therefore, in the same manner as the first printing operation, when the printing is performed on an end of the second band region RP2 in the X2 direction, the arm portion 220 of the robot 2 is in an extended state. On the other hand, when the printing is performed on an end of the second band region RP2 in the X1 direction, the arm portion 220 of the robot 2 is in a contracted state.

Meanwhile, a center line of the second band region RP2 coincides with a virtual straight line passing through the rotation axis O1 when viewed in the direction along the Z-axis. Therefore, when executing the second printing operation, it is sufficient to operate the three joints 230 of the rotation axes O2, O3, and O5 orthogonal to the rotation axis O1, that is, only the joints 230_2, 230_3, and 230_5. Therefore, when the printing is performed on the second band region RP2, a vibration due to the operation of the joint 230 of the robot 2 is less likely to affect a print image quality, as compared with the case where the printing is performed on the first band region RP1.

Therefore, when the second printing operation is executed, changes of the ejection distance PG and the landing angle θ are less than when the first printing operation is executed.

FIG. 13 is a perspective view describing the trajectory TR1_1, a trajectory TR2, and the trajectory TR1_2 of the head 3a when the first printing operation and the second printing operation are executed in the second embodiment. In the same manner as the first embodiment, the trajectories TR1_1 and TR1_2 are trajectories of the nozzle arrays NL of the head 3a at the time of printing on the first band regions RP1_1 and RP1_2, and are visually recognizable by shaded in FIG. 13. The trajectory TR2 is a trajectory of the nozzle array NL of the head 3a at the time of printing on the second band region RP2, and is visually recognizable by shaded in FIG. 13. In the present embodiment, since the tool center point TCP is set on the nozzle surface FN, it can be said that each of the trajectories TR_1 and the TR_2 is a trajectory of the nozzle surface FN.

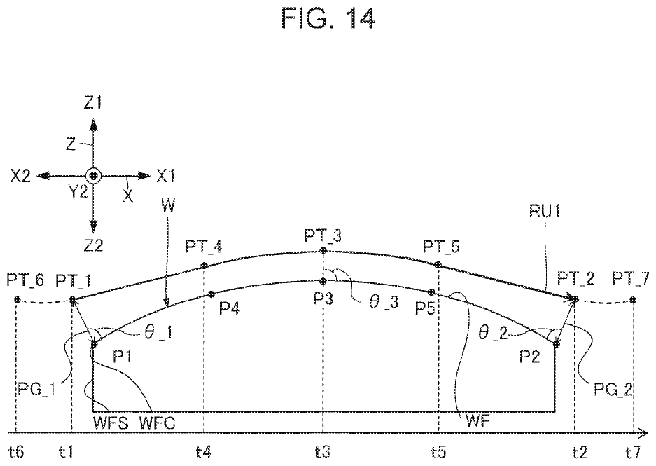

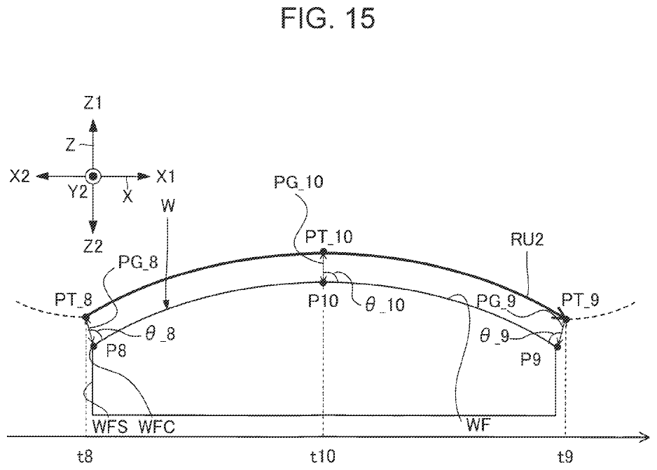

FIG. 14 is a diagram describing the movement path RU1 of the head 3a when the first printing operation according to the second embodiment is executed. FIG. 15 is a diagram describing the movement path RU2 of the head 3a when the second printing operation is executed in the second embodiment. FIGS. 14 and 15 illustrate a case where a movement direction of the head 3a at the time of the execution of the first printing operation and the second printing operation is the X1 direction when viewed in the direction along the Z-axis.

As illustrated in FIG. 14, the movement path RU1 is a movement path of the head 3a when the first printing operation in steps S41 and S43 is executed, and has the same manner as the movement path RU1 of the first embodiment when viewed in the direction along the Y-axis. On the other hand, as illustrated in FIG. 15, the movement path RU2 is a movement path of the head 3a when the second printing operation in step S42 is executed, and is a path close to the movement path RU in the reference example described above than the movement path RU1 when viewed in the direction along the Y-axis. The movement path RU2 may have the same manner as the movement path RU of the reference example when viewed in the direction along the Y-axis.

The movement path RU2 is defined by a plurality of teaching points including teaching points PT_8, PT_9, and PT_10.

The teaching point PT_8 is the teaching point PT indicating a relative position between the workpiece W and the head 3a at a timing t8. The timing t8 is an example of an “eighth timing”, and is a timing at which the second printing operation is started. An ink ejected from the head 3a at the timing t8 is applied to the surface WF at a position P8. In the example illustrated in FIG. 14, the position P8 is located at an end at which the corner WC is formed at the surface WF.

The teaching point PT_9 is the teaching point PT indicating the relative position between the workpiece W and the head 3a at a timing t9. The timing t9 is an example of a “ninth timing”, and is a timing at which the second printing operation ends. The ink ejected from the head 3a at the timing t9 is applied to the surface WF at the position P9.

The teaching point PT_10 is the teaching point PT indicating the relative position between the workpiece W and the head 3a at a timing t10. The timing t10 is a timing between the timing t8 and the timing t9. The ink ejected from the head 3a at the timing t10 is applied to the surface WF at a position P10.

In the movement path RU2 defined by the plurality of teaching points including such teaching points PT_8, PT_9, and PT_10, from the viewpoint of achieving both productivity and an image quality, an ejection distance PG_8 based on the teaching point PT_8, that is, the ejection distance PG at the timing t8 is less than the ejection distance PG_1 based on the teaching point PT_1 of the movement path RU1, that is, the ejection distance PG at the timing t1. In the same manner, an ejection distance PG_9 based on the teaching point PT_9, that is, the ejection distance PG at the timing t9 is less than the ejection distance PG_2 based on the teaching point PT_2 of the movement path RU1, that is, the ejection distance PG at the timing t2. An ejection distance PG_10 based on the teaching point PT_10, that is, the ejection distance PG at the timing t10 may be equal to the ejection distance PG_3 based on the teaching point PT_3 of the movement path RU1, that is, the ejection distance PG at the timing t3.

By using such teaching points PT_8, PT_9, and PT_10, the ejection distance PG_8 based on the teaching point PT_8, the ejection distance PG_9 based on the teaching point PT_9, and the ejection distance PG_10 based on the teaching point PT_10 can be set to be equal to each other. Although a landing angle θ_8 based on the teaching point PT_8, a landing angle θ_9 based on the teaching point PT_9, and a landing angle θ_10 based on the teaching point PT_10 may be different from each other, the landing angle θ_8, the landing angle θ_9, and the landing angle θ_10 may be equal to each other from the viewpoint of improving the image quality. Meanwhile, for example, when an image quality difference becomes remarkable between the first band region RP1 and the second band region RP2, or when the image quality of the second band region RP2 is reduced due to the vibration of the robot 2 in the second printing operation, the ejection distance PG_8 may be more than the ejection distance PG_10 or the ejection distance PG_3 and less than the ejection distance PG_1. In the same manner, the ejection distance PG_9 may be more than the ejection distance PG_10 or the ejection distance PG_3 and less than the ejection distance PG_2. Further, the landing angle θ_8 may be an angle between the landing angle θ_10 or the landing angle θ_3 and the landing angle θ_1. In the same manner, the landing angle θ_9 may be an angle between the landing angle θ_10 or the landing angle θ_3 and the landing angle θ_2.

Depending on the arrangement of the workpiece W and the like, the ejection distance PG_8 may be more than the ejection distance PG_1, or the ejection distance PG_9 may be more than the ejection distance PG_2. Further, when the ejection distance PG_8 is different from the ejection distance PG_1, the ejection distance PG_9 may be equal to the ejection distance PG_2. In the same manner, when the ejection distance PG_9 is different from the ejection distance PG_2, the ejection distance PG_8 may be equal to the ejection distance PG_1.

According to the above second embodiment as well, the print image quality can be improved while reducing the vibration due to the operation of the robot 2. As described above, the printing apparatus 1 according to the present embodiment executes the second printing operation. In the second printing operation, the robot 2 ejects inks from the head 3awhile changing the relative position between the workpiece W and the head 3a. Therefore, the printing is performed on the second band region RP2 adjacent to the first band region RP1 on the workpiece W. Thereafter, when a timing at which the second printing operation is started is set as the timing t8 which is an example of the “eighth timing”, and a timing at which the second printing operation ends is set as the timing t9 which is an example of the “ninth timing”, one or both of the fact that the ejection distance PG at the timing t1 and the ejection distance PG at the timing t8 are different from each other and the fact that the ejection distance PG at the timing t2 and the ejection distance PG at the timing t8 are different from each other are satisfied. Therefore, the printing can be performed on the first band region RP1 and the second band region RP2 while achieving both the productivity and the image quality.

### 3. MODIFICATION EXAMPLE

Each embodiment in the above examples can be variously modified. Specific modification aspects that can be applied to each embodiment described above will be described below. The two or more aspects freely selected from the following examples can be appropriately merged within a range not mutually contradictory.

### 3-1. Modification Example 1

In each of the embodiments described above, the mode in which both the ejection distance and the landing angle at the time of printing on the first band region are different between the first timing or the second timing and the third timing is described. Meanwhile, only one of the ejection distance and the landing angle at the time of the printing on the first band region may be different between the first timing or the second timing and the third timing.

Further, the ejection distance or the landing angle may be different between one of the first timing and the second timing, and the third timing, and the ejection distance or the landing angle may be the same at the other of the first timing and the second timing, and the third timing.

### 3-2. Modification Example 2

In the embodiment described above, the mode of performing the borderless printing is described. Meanwhile, the embodiment is not limited to the mode, and the position P1 may be a position away from the corner WC.

### 3-3. Modification Example 3

In the embodiment described above, the case where the movement direction of the head 3a is the X1 direction when the first printing operation and the second printing operation are executed when viewed in the direction along the Z-axis is described. Meanwhile, the present disclosure is not limited thereto. For example, the movement direction of the head 3a at the time of the execution of the first printing operation and the second printing operation may be the X2 direction when viewed in the direction along the Z-axis, the movement direction of the head 3a at the time of the execution of the first printing operation and the second printing operation may be a direction orthogonal to the X-axis when viewed in the direction along the Z-axis, and the movement direction of the head 3a at the time of the execution of the first printing operation and the second printing operation may be a direction inclined to both the X-axis and the Y-axis when viewed in the direction along the Z-axis.

### 3-4. Modification Example 4

In the embodiment described above, the configuration using the 6-axis vertical multi-axis robot as the robot is described. Meanwhile, the configuration is not limited to this configuration. The robot may be, for example, a vertical multi-axis robot other than the 6-axis robot, or a horizontal multi-axis robot. Further, the arm portion of the robot may have a telescopic mechanism, a linear motion mechanism, or the like in addition to the joint configured with the rotation mechanism. Meanwhile, from the viewpoint of the balance between the print quality in the printing operation and the degree of freedom of the robot operation in the non-printing operation, the robot may be a multi-axis robot having 6 axes or more.

### 3-5. Modification Example 5

In the embodiment described above, the configuration using screwing or the like as a method of fixing the head to the robot is described, and the configuration is not limited to this configuration. For example, the head may be fixed to the robot by gripping the head with a gripping mechanism such as a hand mounted as an end effector of the robot.

### 3-6. Modification Example 6

Although the robot having the configuration for moving the head is illustrated in the embodiment described above, the present disclosure is not limited to this configuration. For example, the position of the head may be fixed, the workpiece may be moved by the robot, and the position and the posture of the workpiece to the head may be changed three-dimensionally. In this case, for example, the workpiece is gripped by a gripping mechanism such as a hand mounted to the tip of the robot arm.

### 3-7. Modification Example 7

In the embodiment described above, the configuration in which printing is performed by using one type of ink is described. Meanwhile, the configuration is not limited to this configuration, and the present disclosure can be applied to a configuration in which printing is performed by using two or more types of ink.

### 3-8. Modification Example 8

The use of the printing apparatus of the present disclosure is not limited to image printing. For example, a printing apparatus that ejects a solution of a coloring material is used as a manufacturing apparatus for forming a color filter of a liquid crystal display device. Further, a printing apparatus that ejects a solution of a conductive material is used as a manufacturing apparatus for forming wiring or electrodes on a wiring substrate. The printing apparatus can also be used as a jet dispenser for applying a liquid such as an adhesive to a medium.

What is claimed is:

1. A printing apparatus comprising:
a head including a nozzle surface provided with a plurality of nozzles for ejecting a liquid; and
a robot that includes a plurality of joints configured to rotate around rotation axes different from each other, and changes a relative position of the head with respect to a workpiece, wherein
a first printing operation of performing printing on a first band region on the workpiece is executed by causing the head to eject the liquid while causing the robot to change the relative position of the head with respect to the workpiece, and
when a timing at which the first printing operation is started is set as a first timing,
a timing at which the first printing operation ends is set as a second timing,
a timing between the first timing and the second timing is set as a third timing, and
a distance between the plurality of nozzles and the workpiece along a normal direction of the nozzle surface is set as an ejection distance,
the ejection distance at one or both of the first timing and the second timing is more than the ejection distance at the third timing.

2. The printing apparatus according to claim 1, wherein
the ejection distance at the first timing is more than the ejection distance at the third timing.

3. The printing apparatus according to claim 2, wherein
when a timing between the first timing and the third timing is set as a fourth timing,
the ejection distance at the fourth timing is more than the ejection distance at the third timing, and is less than the ejection distance at the first timing.

4. The printing apparatus according to claim 1, wherein
the ejection distance at the second timing is more than the ejection distance at the third timing.

5. The printing apparatus according to claim 4, wherein
when a timing between the second timing and the third timing is set as a fifth timing,
the ejection distance at the fifth timing is more than the ejection distance at the third timing, and is less than the ejection distance at the second timing.

6. The printing apparatus according to claim 1, wherein
the ejection distance is constant over at least a part of a period including the third timing and not including the first timing and the second timing.

7. The printing apparatus according to claim 1, wherein
a relative posture between the workpiece and the head is changed during the execution of the first printing operation.

8. The printing apparatus according to claim 2, wherein
the workpiece has a first surface and a second surface facing a direction different from a direction of the first surface,
a projecting corner by the first surface and the second surface is formed between the first surface and the second surface,
the first band region is a region within the first surface, and
when a position of the first surface to which the liquid is applied from the head at the first timing is set as a first position, and
a position of the first surface to which the liquid is applied from the head at the third timing is set as a third position,
the first position is closer to the corner and the second surface than the third position.

9. The printing apparatus according to claim 8, wherein
the first position is located at an end at which the corner is formed at the first surface.

10. The printing apparatus according to claim 2, wherein
a first non-printing operation of not ejecting the liquid from the head while causing the robot to change the relative position between the workpiece and the head is executed immediately before the execution of the first printing operation, and
when any timing during the execution of the first non-printing operation is set as a sixth timing,
the ejection distance at the sixth timing is more than the ejection distance at the first timing.

11. The printing apparatus according to claim 10, further comprising:
a control portion that controls an operation of the robot, wherein
the control portion acquires path information on a set of a plurality of teaching points that define the relative position between the workpiece and the head in each of the first printing operation and the first non-printing operation in a virtual space,
the plurality of teaching points include
a first teaching point which is a teaching point indicating the relative position between the workpiece and the head at the first timing,
a third teaching point which is a teaching point indicating the relative position between the workpiece and the head at the third timing, and
a sixth teaching point which is a teaching point indicating the relative position between the workpiece and the head at the sixth timing, and
in the virtual space, the ejection distance based on the first teaching point is more than the ejection distance based on the third teaching point, and less than the ejection distance based on the sixth teaching point.

12. The printing apparatus according to claim 4, wherein
a second non-printing operation of not ejecting the liquid from the head while causing the robot to change the relative position between the workpiece and the head is executed immediately after the execution of the first printing operation, and
when any timing during the execution of the second non-printing operation is set as a seventh timing,
the ejection distance at the seventh timing is more than the ejection distance at the second timing.

13. The printing apparatus according to claim 12, further comprising:
a control portion that controls an operation of the robot, wherein
the control portion acquires path information on a set of a plurality of teaching points that define the relative position between the workpiece and the head in each of the first printing operation and the second non-printing operation in a virtual space,
the plurality of teaching points include
a second teaching point which is a teaching point indicating the relative position between the workpiece and the head at the second timing,
a third teaching point which is a teaching point indicating the relative position between the workpiece and the head at the third timing, and
a seventh teaching point which is a teaching point indicating the relative position between the workpiece and the head at the seventh timing, and
in the virtual space, the ejection distance based on the second teaching point is more than the ejection distance based on the third teaching point, and less than the ejection distance based on the seventh teaching point.

14. The printing apparatus according to claim 1, wherein
a second printing operation of performing printing on a second band region adjacent to the first band region on the workpiece is executed by causing the head to eject the liquid while causing the robot to change the relative position between the workpiece and the head,
when a timing at which the second printing operation is started is set as an eighth timing, and
a timing at which the second printing operation ends is set as a ninth timing,
one or both of a condition in which the ejection distance at the first timing and the ejection distance at the eighth timing are different from each other, and a condition in which the ejection distance at the second timing and the ejection distance at the ninth timing are different from each other are satisfied.

15. A printing apparatus comprising:
a head including a nozzle surface provided with a plurality of nozzles for ejecting a liquid; and
a robot that includes a plurality of joints configured to rotate around rotation axes different from each other, and changes a relative position of the head with respect to a workpiece, wherein
a first printing operation of performing printing on a first band region on the workpiece is executed by causing the head to eject the liquid while causing the robot to change the relative position of the head with respect to the workpiece, and
when a timing at which the first printing operation is started is set as a first timing,
a timing at which the first printing operation ends is set as a second timing,
a timing between the first timing and the second timing is set as a third timing, and
an angle formed by a virtual straight line extending from the plurality of nozzles in a normal direction of the nozzle surface and a surface of the workpiece at an intersection point of the virtual straight line and the surface of the workpiece is set as a landing angle,
the landing angle at one or both of the first timing and the second timing is less than the landing angle at the third timing.

16. The printing apparatus according to claim 2, wherein
when an angle formed by a virtual straight line extending from the plurality of nozzles in a normal direction of the nozzle surface and a surface of the workpiece at an intersection point of the virtual straight line and the surface of the workpiece is set as a landing angle,
the landing angle at the first timing is less than the landing angle at the third timing.

17. The printing apparatus according to claim 4, wherein
when an angle formed by a virtual straight line extending from the plurality of nozzles in a normal direction of the nozzle surface and a surface of the workpiece at an intersection point of the virtual straight line and the surface of the workpiece is set as a landing angle,
the landing angle at the second timing is less than the landing angle at the third timing.

18. A printing method using a head including a nozzle surface provided with a plurality of nozzles for ejecting a liquid, and
a robot that includes a plurality of joints configured to rotate around rotation axes different from each other, and changes a relative position of the head with respect to a workpiece, the printing method comprising:
when a first printing operation of performing printing on a first band region on the workpiece is executed by causing the head to eject the liquid while causing the robot to change the relative position of the head with respect to the workpiece,
acquiring path information on a set of a plurality of teaching points that define the relative position between the workpiece and the head in a virtual space before the execution of the first printing operation; and
executing the first printing operation by using the path information, wherein
when a timing at which the first printing operation is started is set as a first timing,
a timing at which the first printing operation ends is set as a second timing,
a timing between the first timing and the second timing is set as a third timing, and
a distance between the plurality of nozzles and the workpiece along a normal direction of the nozzle surface is set as an ejection distance,
the plurality of teaching points include
a first teaching point which is a teaching point indicating the relative position between the workpiece and the head at the first timing,
a second teaching point which is a teaching point indicating the relative position between the workpiece and the head at the second timing, and
a third teaching point which is a teaching point indicating the relative position between the workpiece and the head at the third timing, and
in the virtual space, the ejection distance based on one or both of the first teaching point and the second teaching point is more than the ejection distance based on the third teaching point.
